(19) United States
(12) Patent Application Publication
(10) Pub. No.: US 2022/0145971 A1
(43) Pub. Date: May 12, 2022

(54) HYBRID VEHICLE WITH A COMBINATION ELECTRIC MACHINE AND A TORQUE CONVERTER

(71) Applicant: FORD GLOBAL TECHNOLOGIES, LLC, Dearborn, MI (US)

(72) Inventors: Matthew David HAMMOND, Dearborn, MI (US); Gregory Daniel GOLESKI, Rochester Hills, MI (US); Bryant L. POYNTER, Redford, MI (US); David Gon OH, Canton, MI (US); Bhaskar MARATHE, Clinton Township, MI (US)

(21) Appl. No.: 17/096,308

(22) Filed: Nov. 12, 2020

(51) Int. Cl. F16H 45/02; B60K 6/387

(52) U.S. Cl. CPC F16H 45/02; F16H 2045/0284; B60K 6/387

(57) ABSTRACT

A propulsion system for an electric vehicle including an internal combustion engine and an electric machine disposed in a transmission housing that is attached to the engine. An engine vibration damper is disposed between the engine and the electric machine. A torque converter connects the engine to the turbine shaft and is disposed in the housing radially inboard of the windings of the electric machine. A turbine shaft connected to the electric machine is configured to transfer torque from the engine and the electric machine through the turbine shaft to a planetary gear set connected to the turbine shaft. A disconnect clutch is operatively connected between the engine and the electric machine and is disposed in the housing radially inboard the windings of the electric machine and is connected to the turbine shaft.

### TECHNICAL FIELD

This disclosure relates to a driveline for a hybrid vehicle that includes an internal combustion engine and an electric propulsion electric machine that are configured to be selectively or jointly engaged with a transmission.

### BACKGROUND

Hybrid vehicles include both an internal combustion engine and an electric machine that jointly or alternatively function to propel the vehicle. The electric machine may be used to propel the vehicle provided there is enough stored energy in the propulsion battery to power the electric machine. The internal combustion engine may provide torque to propel the vehicle when the battery is depleted, when there is insufficient torque provided by the electric machine, or to charge the battery with a regenerative braking system.

In some hybrid vehicles, the internal combustion engine, electric machine and transmission are separate assemblies that each have a separate housing. The separate assemblies are stacked and assembled. Stacking the assemblies requires considerable space within the vehicle and adds weight. Added weight reduces energy efficiency and vehicle range.

Heat created by the electric machine makes it necessary to cool the electric machine. The electric machine is housed in a relatively inaccessible location which makes cooling the electric machine a challenge. Coolant circulation systems have been proposed to cool the electric machine, but such systems add cost and weight to the vehicle.

Prior art electric machines included one damper between the internal combustion engine and the electric machine and a second damper between the electric machine and the torque converter. The second damper added weight and increased the space requirements for the vehicle's propulsion system.

This disclosure is directed to solving the above problems and other problems as summarized below.

### SUMMARY

According to one aspect of this disclosure, a propulsion system for an electric vehicle is disclosed that comprises an engine having an input shaft, an electric machine having windings is disposed in a housing that is attached to the engine. An engine vibration damper is disposed between the engine and the electric machine. A torque converter is disposed in the housing and connects the electric machine and the engine to a turbine shaft connected to a turbine of the torque converter to transfer torque from the engine and the electric machine through the turbine shaft. A planetary gear set is disposed in the housing and is configured to receive torque from the turbine shaft. A disconnect clutch is operatively connected between the engine and the torque converter. The disconnect clutch is at least partially disposed in the housing radially inboard relative to the windings and is configured to selectively transfer torque from the input shaft to the torque converter.

According to another aspect of this disclosure, the propulsion system may further comprise a torque converter clutch disposed radially inside the windings of the electric machine that connects the torque converter housing to the turbine shaft. When the torque converter clutch is disengaged torque is provided through the torque converter to the turbine shaft. When the torque converter clutch is engaged the torque converter is bypassed and locks the torque converter housing to the turbine shaft.

The turbine shaft may define three axial channels, wherein a first axial channel supplies fluid to a torque converter clutch piston, a second axial channel supplies fluid to a disconnect clutch piston, and a third axial channel supplies fluid to a balance dam of the torque converter clutch and a balance dam of the disconnect clutch. The propulsion system may include an off-axis electric pump that provides the fluid under pressure to a valve body and supplies the fluid to the first axial channel, the second axial channel, and the third axial channel through a plurality of axially spaced channels defined in a front support wall of the housing. The off-axis electric pump provides sufficient fluid under pressure to fully engage the disconnect clutch.

The propulsion system may further comprise a valve body, an off-axis pump, a torque converter-in port, and a torque converter-out port. The valve body receives fluid from the off-axis pump and supplies the fluid to the torque converter-in port and receives fluid from torque converter-out port.

The electric machine and the torque converter are located directly adjacent to each other and are not separated by a vibration damper.

According to another aspect of this disclosure, a transmission is disclosed for a hybrid electric vehicle having an engine. The transmission comprise a transmission housing operatively connected to an input shaft from the engine. An electric machine is disposed in the transmission housing and connected to a torque converter. The electric machine includes a stator and a rotor that includes a plurality of windings. A torque converter is disposed in the transmission housing and includes a turbine, an impeller, and a stator. The torque converter hydrostatically connects the impeller to the turbine of the torque converter to transfer torque from the engine to a turbine shaft. A planetary gear set is disposed in the transmission housing and is configured to receive torque from the turbine shaft. A torque converter clutch is provided between the torque converter housing and the turbine shaft. The torque converter clutch is disposed in the transmission housing radially inboard relative to the windings of the electric machine. The torque converter clutch is configured to bypass the torque converter and provide torque from the torque converter housing to the turbine shaft.

According to another aspect of this disclosure, a combination electric machine and torque converter assembly is disclosed for a hybrid vehicle including an engine. The combination includes a housing, an electric machine disposed in the housing that includes a stator and a rotor. A torque converter is disposed in the housing and is operatively connected to the electric machine to receive torque from the engine. The torque converter has a disconnect clutch that is engaged to receive torque from an engine and provide torque to a turbine shaft. The disconnect clutch is disposed in the housing at a location radially inside the rotor of the electric machine.

As an alternative, a torque converter clutch may be disposed in the housing radially inside the windings of the rotor. The torque converter clutch functions to lock a torque converter housing to the turbine shaft bypassing the torque converter.

The above aspects of this disclosure and other aspects will be described below with reference to the attached drawings.

### BRIEF DESCRIPTION OF THE DRAWINGS

FIG. 1 is a schematic diagram of an electric vehicle.

FIG. 2 is a diagrammatic cross-sectional view of a propulsion system for an electric vehicle.

FIG. 3 is a cross-sectional view taken along the line 3-3 in FIG. 2.

FIG. 4 is a cross-sectional view of a turbine shaft taken along the line 4-4 in FIG. 2.

FIG. 5 is a cross-sectional view of a turbine shaft taken along the line 5-5 in FIG. 2.

FIG. 6 is a schematic view of a planetary gear set.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure could be incorporated in particular applications or implementations.

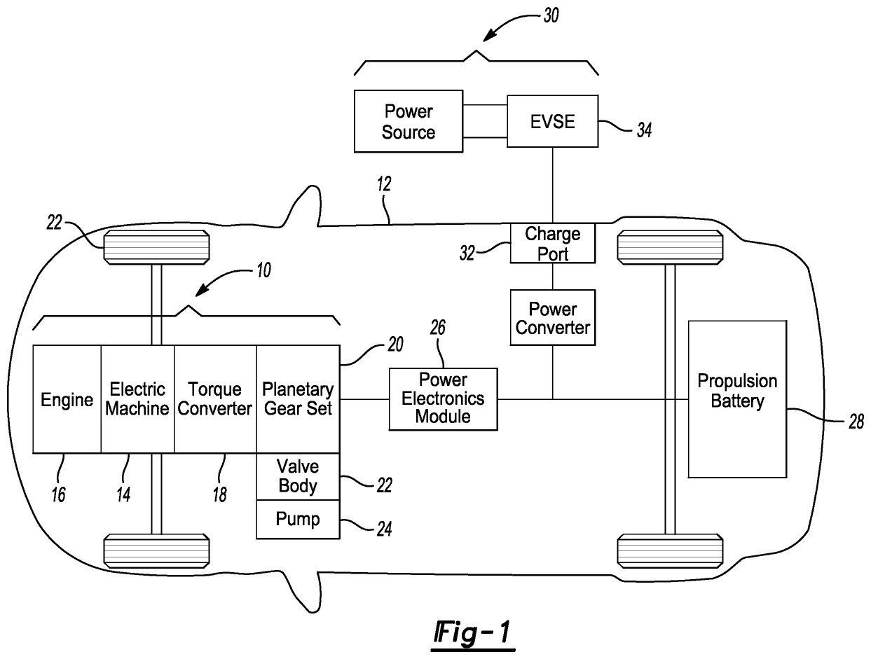

Referring to FIG. 1, a propulsion system 10 for a hybrid vehicle 12 is illustrated that includes an electric machine 14 for propelling the vehicle 12, an internal combustion engine (“ICE”) 16, a torque converter 18, a multi-speed planetary gear set 20, a valve body 22, and an off-axis transmission fluid pump 24. Power is provided to the electric machine 14 through a power electronics module 26 from a propulsion battery 28. The propulsion battery 28 may include a plug-in charging station 30 including a power source, such as the electrical power grid (not shown) and electrical vehicle supply equipment (“EVSE”). If the vehicle 12 is a plug-in hybrid, a charge port 32 and a power converter 34 may be provided to charge the battery 28.

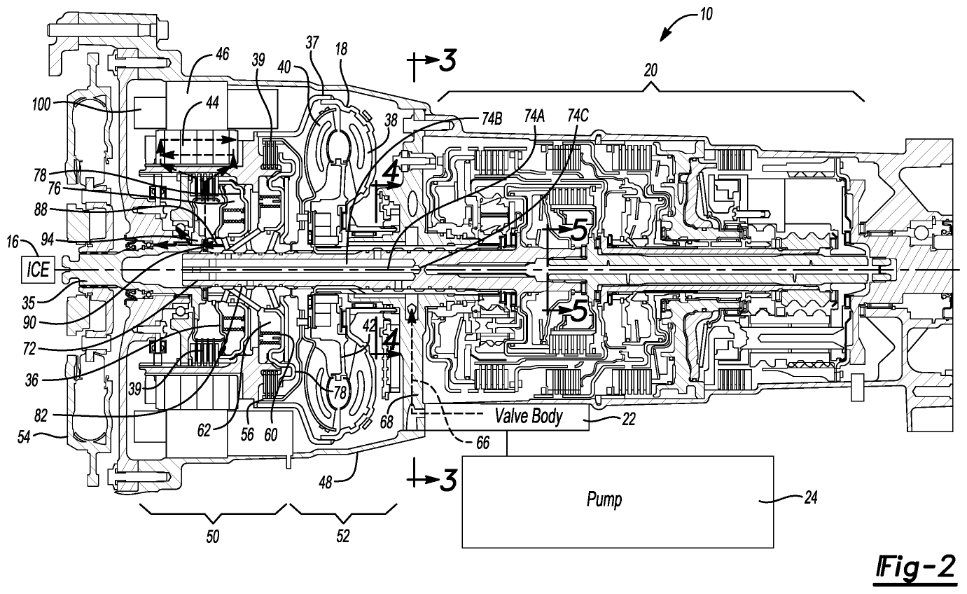

Referring to FIG. 2, the ICE 16 is of conventional design and may be a gasoline or diesel engine. The ICE 16 is configured to be attached to the propulsion system 10 with an input shaft 35 that is selectively connected to the torque converter 18 by a disconnect clutch 36 (hereinafter a “KO clutch”). When the KO clutch 36 is engaged, torque from the ICE 16 is provided to the torque converter housing 37 which is connected to the impeller 38 of the torque converter 18. The impeller 38 drives the turbine 40 of the torque converter 18 through the TC stator 42 that multiplies the torque for better acceleration.

The electric machine 14 includes a rotor 44 that is connected to the housing 37 of the torque converter 18 and a stator 46 of the electric machine 14. The electric machine 14 may propel the vehicle 12 (shown in FIG. 1) independently, in conjunction with the ICE 16, or the ICE 16 may propel the vehicle 12 independently.

A housing 48 encloses the electric machine 14 and torque converter 18. A damper 54 is disposed between the ICE 16 and the housing 48 to dampen vibrations from the ICE 16. According to one aspect of this disclosure, no damper is provided between the electric machine 14 and the torque converter 18. Elimination of the damper as previously provided in the prior art allows parts of the torque converter 18 to be disposed radially inside the electric machine 14 to reduce the overall length of the propulsion system 10.

The ICE 16 provides torque through the input shaft 35 to the KO clutch 36. The KO clutch 36 is engaged to provide torque to the torque converter 18 and is released to interrupt or limit the torque provided by the ICE 16 to the torque converter 18. The KO clutch 36 includes a clutch pack 39 that includes clutch plates and friction material that connect the ICE 16 input shaft 35 to the torque converter 18. The KO clutch 36 includes a KO piston 78 and a KO balance dam 76. The KO clutch 36 is controlled by automatic transmission fluid (hereinafter “ATF”) pressurized by an off-axis pump 24 and controlled by a computer-controlled valve body 22.

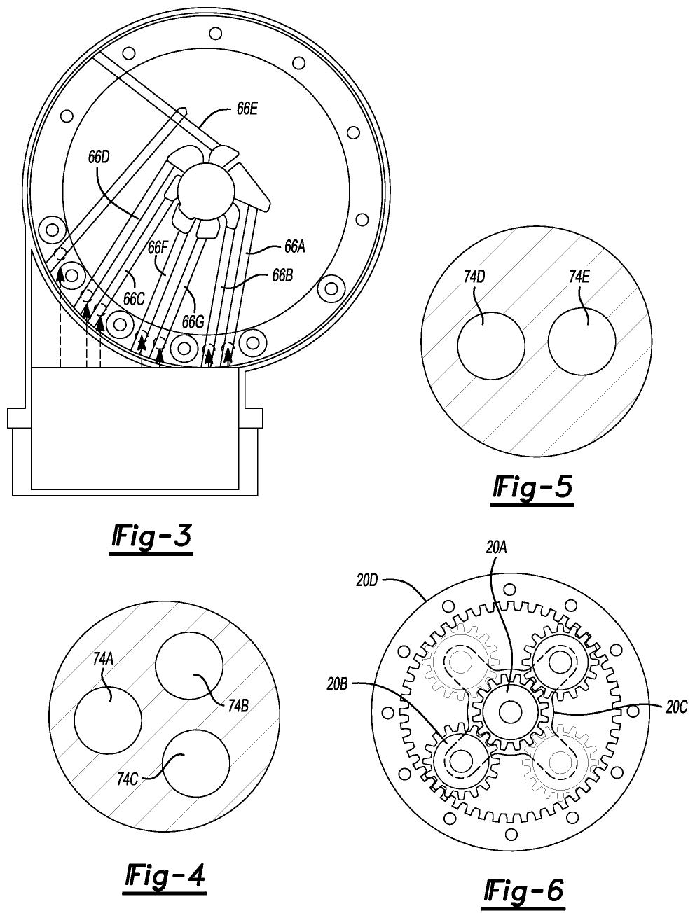

Referring to FIGS. 2 and 3, ATF is provided through channels 66 in a front support 68 of the portion of the housing 48 enclosing the gear set 20. The channels 66 provide fluid to the turbine shaft 72. The channels 66 include a torque converter in channel 66A, a torque converter out channel 66B, a TC clutch piston channel 66C, a KO clutch piston channel 66D, and a balance dam channel 66E. Two channels 66F and 66G are in fluid flow communication through the turbine shaft 72 (shown in FIG. 5) to the gear set 20 as will be described below. The gear set 20, as illustrated, is of conventional design and includes a plurality of planetary gear sets.

Referring to FIGS. 2 and 4, the turbine shaft 72 defines a plurality of feeds 74 that extend axially through the shaft 72. One of the feeds 74A is in fluid flow communication with the TC piston 60. A second feed 74B is in fluid flow communication with the KO piston 78. A third feed 74C is in fluid flow communication with both the TC balance dam 62 and KO balance dam 76. In one embodiment, the third feed 74C also supplies ATF top lubricate the electric machine 14. The turbine shaft 72 also includes two feeds 74D and 74E (shown in FIG. 5) that are in fluid flow communication with the gear set 20.

Torque converter clutch 56, or “TC clutch,” is engaged to transfer torque directly from the torque converter housing 37 to the turbine 40 and the turbine shaft 72. The TC clutch 56 is engaged to improve efficiency by eliminating energy losses inherent in the torque converter 18 operation. Engaging the TC clutch 56 locks the torque converter housing 37 to the turbine shaft 72.

The torque converter clutch 56 includes TC piston 60 in fluid communication with TC piston feed 74A for actuating the TC clutch 56. When the TC clutch 56 is actuated, the torque converter 18 is bypassed and torque from the ICE 16 is mechanically connected, or locked, by the TC clutch 56 to the turbine shaft 72.

The balance dam feed 74C is in fluid flow communication with both the torque converter balance dam 62 (hereinafter “TC balance dam”) and the KO balance dam 76. Three or four cross-drilled holes 82 are defined by the turbine shaft 72. The cross drilled holes 82 in the turbine shaft are open with the feed 74A being open to the TC piston 60, feed 74B being open to the KO clutch piston 78, and feed 74C being open to balance dams 62 and 76.

In one embodiment, a lubrication feed 88 receives ATF through the cross-drilled holes 82 and supplies ATF to a thrust bearing 90 disposed between the turbine shaft 72 and the input shaft 35. The electric machine 14 includes magnets (not shown) in the rotor 44 that are heated as a result of electric machine 14 operation and require cooling. The thrust bearing 90 splashes the ATF outwardly to cool and lubricate the electric machine 14. The balance dam feed 74C provides fluid flow communication with the TC balance dam 62, The KO balance dam 76, and the lubrication feed 88.

The TC piston 60 is actuated to apply the TC clutch 56. When the TC clutch 56 is actuated, ATF is supplied through the TC piston feed 74A and fluid in the TC balance dam 62 flows back to the feed 74C. Similarly, when the KO clutch 36 is actuated, ATF is provided through the KO piston feed 74B to the KO piston 78 and fluid in the KO balance dam 76 flows back to the feed 74C.

Referring to FIG. 6, (shown in FIG. 5) the planetary gear sets 20 each include a sun gear 20A about which planet gears 20B rotate within a ring gear 20D. A carrier 20C connects the planet gears 20B. The sun gears 20A, ring gears 20D and carriers 20C are selectively locked to change the gear ratio as is well-known in the art.

The valve body 22 receives pressurized ATF from the pump 24 and selectively supplies ATF to clutches associated with the torque converter in-channel 66A, the torque converter out-channel 66B, the TC piston channel 66C, the balance dam channel 66E, and the two channels 66F and 66G that are in fluid flow communication with the planetary gear set 20.

The KO clutch 36 is assembled radially inside the windings 100 of the stator 42 to reduce the overall length of the propulsion system 10. The TC clutch 56 is assembled at least partially radially inside the windings 92. In the illustrated example, the clutch pack 58 and balance dam 62 are disposed at a location radially inside the electric machine 14. By eliminating a damper from between the electric machine 14 and the torque converter 18, space is requirements are reduced by locating the KO clutch 36 and TC clutch 56 fully or partially radially inside the windings 92 of the electric machine 14.

The propulsion system 10 has three modes of operation including a first mode—engine 16 only; a second mode—electric machine 14 only; and a third mode—with both the engine 16 and electric machine 14 providing torque to the turbine shaft 72 and planetary gear set 20.

In the first mode of operation, the KO clutch 36 is engaged and torque from the ICE 16 is provided through the torque converter housing 37 to the torque converter 18. The impeller 38 drives the turbine 40 through the TC stator 42 and provides torque to the turbine shaft 72 and planetary gear set 20. When the TC clutch 56 is engaged, the torque converter housing 37 provides torque directly to the turbine shaft 72 and the planetary gear set 20.

In the second mode of operation, torque from the electric machine 14 is provided to the turbine shaft 72 through the torque converter 18.

In the third mode of operation, torque from the ICE 16 is provided to the torque converter housing 37 by engaging the KO clutch 56 while torque from the electric machine 14 is provided directly to the torque converter housing 37. Torque from the torque converter housing 37 is provided to the turbine shaft 72 through the torque converter 18.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A propulsion system for an electric vehicle comprising:
an engine having an input shaft;
an electric machine disposed in a housing that is attached to the engine, the electric machine having windings;
an engine vibration damper disposed between the engine and the electric machine;
a torque converter disposed in the housing connects the electric machine and the engine to a turbine shaft connected to a turbine of the torque converter to transfer torque from the engine and the electric machine through the turbine shaft;
a planetary gear set disposed in the housing being configured to receive torque from the turbine shaft;
a disconnect clutch operatively connected between the engine and the torque converter, the disconnect clutch being disposed in the housing radially inboard relative to the windings, wherein the windings axially overlap the disconnect clutch, and wherein the disconnect clutch is configured to selectively transfer torque from the input shaft to the torque converter; and
a torque converter clutch disposed radially inboard of the windings of the electric machine that connects a torque converter housing to the turbine shaft, wherein the windings axially overlap the disconnect clutch, and wherein the torque converter clutch when disengaged provides torque through the torque converter to the turbine shaft, the torque converter when engaged bypasses the torque converter and locks the torque converter housing to the turbine shaft.

2. (canceled)

3. The propulsion system of claim 2 wherein the turbine shaft defines three axial channels, a first axial channel supplies fluid to a torque converter clutch piston, a second axial channel supplies fluid to a disconnect clutch piston, and a third axial channel supplies fluid to a balance dam of the torque converter clutch and a balance dam of the disconnect clutch.

4. The propulsion system of claim 3 further comprising:
an off-axis electric pump that provides the fluid under pressure to a valve body and supplies the fluid to the first axial channel, the second axial channel, and the third axial channel through a plurality of axially spaced channels defined in a front support wall of the housing.

5. The propulsion system of claim 2 wherein an off-axis electric pump provides fluid under pressure sufficient to engage the disconnect clutch.

6. The propulsion system of claim 1 further comprising:
a valve body;
an off-axis pump;
a torque converter-in port; and
a torque converter-out port, wherein the valve body receives fluid from the off-axis pump and supplies the fluid to the torque converter-in port and receives fluid from torque converter-out port.

7. The propulsion system of claim 1 wherein the electric machine and the torque converter are directly adjacent to each other and are not separated by a vibration damper.

8. A transmission for a hybrid electric vehicle having an engine, the transmission comprising:
a transmission housing operatively connected to the engine having an input shaft;
an electric machine disposed in the transmission housing and connected to a torque converter, wherein the electric machine includes a stator including a plurality of windings, and a rotor;
wherein the torque converter is disposed in the transmission housing and includes a turbine, an impeller, and a stator, wherein the torque converter hydrostatically connects the impeller to the turbine of the torque converter to transfer torque from the engine to a turbine shaft;
a planetary gear set disposed in the transmission housing being configured to receive torque from the turbine shaft;
a torque converter clutch provided between a torque converter housing and the turbine shaft, wherein the torque converter clutch is disposed in the transmission housing radially inboard relative to the windings of the electric machine, wherein the windings axially overlap the torque converter clutch, and wherein the torque converter clutch is configured to bypass the torque converter and provide torque from the torque converter housing to the turbine shaft; and
a disconnect clutch disposed radially inside the windings of the electric machine, wherein the windings axially overlap the disconnect clutch that connects the input shaft to the torque converter to transfer torque from the engine to a turbine shaft.

9. (canceled)

10. The transmission of claim 9 wherein the turbine shaft defines three axial channels, a first axial channel supplies fluid to a torque converter clutch piston, a second axial channel supplies fluid to a disconnect clutch piston, and a third axial channel supplies fluid to a balance dam of the torque converter clutch and a balance dam of the disconnect clutch.

11. The transmission of claim 10 further comprising:
an off-axis electric pump that provides fluid under pressure to a valve body and supplies the fluid to the first axial channel, the second axial channel, and the third axial channel defined in a front support wall of a planetary gear set housing.

12. The transmission of claim 11 wherein the off-axis electric pump provides fluid under pressure sufficient to engage the disconnect clutch.

13. The transmission of claim 8 further comprising:
a valve body;
an off-axis pump;
a torque converter-in port; and
a torque converter-out port, wherein the valve body receives fluid from the off-axis pump and supplies the fluid to the torque converter-in port and receives fluid from torque converter-out port.

14. The transmission of claim 8 wherein the electric machine and the torque converter are directly adjacent to each other and are not separated by a vibration damper.

15. A combination electric machine and torque converter assembly for a hybrid vehicle including an engine, the combination comprising:
an electric machine disposed in a housing and including a stator, and a rotor including windings;
a torque converter disposed in the housing and operatively connected to the electric machine to receive torque from the engine, wherein the torque converter has a disconnect clutch that is engaged to receive torque from an engine and provide torque to a turbine shaft, and wherein the disconnect clutch is disposed in the housing at a location radially inside the rotor of the electric machine, wherein the windings axially overlap the disconnect clutch; and
a torque converter clutch disposed in the housing and radially inside the windings of the electric machine, wherein the winding axially overlap the torque converter clutch, wherein the torque converter clutch locks a torque converter housing to the turbine shaft bypassing the torque converter.

16. (canceled)

17. The combination of claim 15 wherein the turbine shaft is configured to receive torque from a turbine of the torque converter and provide torque through the turbine shaft to a gear set.
